(19) United States
(12) Patent Application Publication
(10) Pub. No.: US 2026/0128536 A1
(43) Pub. Date: May 7, 2026

(54) ELECTRICAL CONNECTOR FOR MULTIPLE CABLE SIZES

(71) Applicant: Junjie Huang, FUZHOU (CN)

(72) Inventor: Junjie Huang, FUZHOU (CN)

(21) Appl. No.: 18/940,008

(22) Filed: Nov. 7, 2024

(51) Int. Cl. H01R 11/26; H01R 31/06

(52) U.S. Cl. CPC H01R 11/26; H01R 31/06

(57) ABSTRACT

The invention is an electrical connector for multiple cable sizes, including a body, a stop plate, a strap, and a fastener. The body features a hollow cylindrical section for cable butting and a clamping section at one end. The locking tab of the strap is inserted into the slot for convenient positioning and rotation. Meanwhile, the first and second locking regions cooperate with the fastener to firmly secure cables. Stop plates with specific inner diameters prevent cable armor from penetrating into electrical equipment, thereby enhancing assembly stability and safety. This connector simplifies the assembly and fixing processes for cables with various outer diameters.

### FIELD OF THE INVENTION

The present invention relates to the technical field of electrical connectors, and in particular to an electrical connector for multiple cable sizes.

### BACKGROUND OF THE INVENTION

In the cables connected by these electrical connectors, it typically connects and secures flexible metal conduits or metal armored cables or jacketed metal armored cables with electrical panels or electrical equipment. The cables include flexible metal conduits or metal armored cables or jacketed metal armored cables.

The metal armored cable or jacketed metal armored cable has a cable inside, and the flexible metal conduit can also have a cable inside. The above only allows the cable or wire to penetrate into the electrical equipment or electrical panel, but does not allow the metal armored conduits and flexible metal conduits to penetrate into the electrical equipment or electrical panel. Otherwise, there will be some safety risks and damages.

The existing electrical connector has the following installation forms. The first form, one specification of connector can only correspond to an appropriate size of conduit or cable. There may be situations that the above-mentioned connectors and conduits or cables from different manufacturers cannot be matched at the same time due to the existence of the tolerance phenomenon in the production. The second form, the above-mentioned conduits or cables with various outer diameters can be installed with one specification of connector that configured with different inner diameter sizes of stop plates. However, when the connector is installed upwards, it is necessary to firstly plug and press the stop plate having the variable inner diameter into the electrical connector, and then install the corresponding above-mentioned conduits or cables into the electrical connector by another one. The above-mentioned structures have the problems of poor adaptability, too many operation steps and long assembly time.

### SUMMARY OF THE INVENTION

For this reason, it is necessary to provide an electrical connector for multiple cable sizes, so as to solve the problems of poor adaptability, too many operation steps and long assembly time of the electrical connector structures in the prior art.

In order to achieve the above-mentioned object, the inventors provide an electrical connector for multiple cable sizes, including a body, a stop plate, a strap and a fastener;

the body includes an hollow cylindrical section and a clamping section, wherein the clamping section is connected to an end of the hollow cylindrical section; a slot is provided at one side of the clamping section, and a first locking region is provided at the other side of the clamping section;

the stop plate is assembled at one end of the hollow cylindrical section that connected to the clamping section; the stop plate is provided with an opening that communicate with the inner side surface of the hollow cylindrical section, and the size of the opening is less than the inner diameter of the hollow cylindrical section;

a locking tab is provided at one side of the strap, and a second locking region is provided at the other side; the strap contacts with the slot of the clamping section via the locking tab, and a rotation point is formed in the contact region between the locking tab and the slot of the clamping section; a cable clamping region is formed in a region between the strap and the clamping section; and the fastener is connected to the first locking region and the second locking region for adjusting the size of the space in the cable clamping region.

Compared with the prior art, the above-mentioned technical solution has the following advantages. The hollow cylindrical section of the body is provided to facilitate the butting of cables. The clamping section is provided at an end of the hollow cylindrical section. On one side, the locking tab of the strap is inserted into the body slot to facilitate the positioning and rotation. On the other side, the first locking region and the second locking region cooperate with the fastener to clamp and fix the cables in the cable clamping region so as to facilitate the assembly and fixing for different cable sizes, and the opening size of the configured stop plate is less than the inner diameter of the hollow cylindrical section, which is possible to prevent the metal armor or flexible metal conduit of the cable from penetrating into the electrical equipment or electrical panel at the other end of the hollow cylindrical section from the body, improving assembly stability and safety.

As a preferred embodiment of the invention, the said clamping section of the body has an arc-shaped structure. The one side of the strap and the slot in one side of the clamping section can be connected or detached by a bolt that facilitate clamping and assembling operation.

As a preferred embodiment of the invention, the said strap has an arc-shaped structure that increases the contact area with the cable, improving the stability of the cable clamping and assembly.

As a preferred embodiment of the invention, the said locking tab is provided at one side of the strap. The locking tab has an arc-shaped structure. The strap is in contact with the slot of the clamping section via the locking tab, and a rotation point is formed in the contact region between the locking tab and the slot of the clamping section. A cable clamping region is formed in a region between the strap and the clamping section By taking the locking tab of the strap as an arc-shaped structure, after the arc-shaped structure is inserted into the slot, the assembly region of the strap is stabilized. The locking tab can prevent the strap from being separated from the slot when the fastener locks the first locking region and the second locking region.

As a preferred embodiment of the invention, the said locking tab is provided at one side of the strap. The strap is in contact with the slot of the clamping section via the locking tab. The locking tab of the strap is arranged at an included angle with the strap, and a rotation point is formed in the contact region between the locking tab and the slot of the clamping section. A cable clamping region is formed in a region between the strap and the clamping section by arranging the locking tab of the strap at an included angle with the strap. When the strap adopts a flat plate structure, the locking tab can prevent the strap from being separated from the slot when the fastener locks the first locking region and the second locking region.

As a preferred embodiment of the invention, the said stop plate is provided with a hook section and a plug-in section. The hook section is hooked on the hollow cylindrical section. One end of the clamping section connected to the hollow cylindrical section is provided with a plug-in hole; the plug-in section is plugged in the plug-in hole; and the hooking direction of the hook section of the stop plate and the pluging direction of the plug-in section are arranged alternately. By providing the stop plate with a hook section and a plug-in section, it is possible to replace the stop plate according to the specific size of the cable so as to adapt to the end abutting treatment of the cable protection structure.

As a preferred embodiment of the invention, the said outer surface of the hollow cylindrical section is provided with an assembly thread that facilitate the cable butting and fixing process.

As a preferred embodiment of the invention, the said locknut being adapted to the assembly thread of the outer surface of the hollow cylindrical section. By providing a locknut, the fixing operation of the hollow cylindrical section is facilitated.

As a preferred embodiment of the invention, the said first locking region is a threaded hole, and the second locking region is a threaded hole or through hole.

As a preferred embodiment of the invention, the said strap is provided with a fixed protrusion on a side opposite to the clamping section. Further clamping and positioning of the outer surface of the cable, i.e., the flexible metal conduit or the metal armoured cable or the jacketed metal armoured cable, is facilitated by providing the fixed protrusion on the side of the strap opposite to the clamping section.

### BRIEF DESCRIPTION OF THE DRAWINGS

The objects, spirits, and advantages of the preferred embodiments of the present disclosure will be readily understood by the accompanying drawings and detailed descriptions, wherein:

FIG. 1 is a perspective view of an electrical connector for multiple cable sizes in an embodiment of the present invention;

FIG. 2 is a rear view of the electrical connector for multiple cable sizes in an embodiment of the present invention;

FIG. 3 is a schematic view of the three-dimensional structure of a body in an embodiment of the present invention;

FIG. 4 is a schematic cross-sectional view of a stop plate in an embodiment of the present invention;

FIG. 5 is a detailed structural diagram of a strap in an embodiment of the present invention; and

FIG. 6 is a perspective view of another electrical connector for multiple cable sizes in an embodiment of the present invention.

### DESCRIPTION OF THE PREFERRED EMBODIMENTS

T In order to explain the technical contents, structural features, realized objects and effects of the technical solutions in detail, the following detailed description is given in conjunction with the specific embodiments and the accompanying drawings.

In order to explain in detail possible application scenarios, technical principles, practical implementations, and objects and effects of the present application, the following description is made in conjunction with the enumerated specific embodiments and the accompanying drawings. The embodiments described herein are intended only to more clearly illustrate the technical solution of the present application, and are therefore merely exemplary and are not intended to limit the scope of the present application.

Reference herein to “an embodiment” means that a particular feature, structure, or characteristic described in connection with the example may be included in at least one example of the present application. The appearances of the phrase “in an embodiment” in various places in the specification are not necessarily all referring to the same embodiment, nor are they particularly limited in their independence or relevance to other embodiments. In principle, in the present application, as long as there is no technical contradiction or conflict, each technical feature mentioned in each embodiment can be combined in any manner to form a corresponding technical solution which can be implemented.

Unless defined otherwise, technical terms used herein have the same meaning as is commonly understood by one of skill in the art to which this application belongs. The terminology used herein is for the purpose of describing particular embodiments only and is not intended to be limiting of the application.

In the description of the present application, the term “and/or” is an expression used to describe a logical relationship between objects, meaning that three relationships may exist. For example A and/or B indicates that there are three cases, A, B, and both A and B. In addition, the word “/”, as used herein, generally indicates that the associated object is a logical relationship, “or”.

In this application, terms such as “first” and “second” are used solely to distinguish one entity or operation from another entity or operation without necessarily requiring or implying any actual such relationship between such entities or operations.

Without further limitation, the use of the terms “including”, “comprising”,“has”, or other similar expressions in this application are intended to cover non-exclusive inclusions and do not exclude the possibility of additional elements in a process, method or product that includes such elements. Thus, the process, method, or product including a set of elements may include not only those limited elements, but also other elements not explicitly listed, or elements inherent to the process, method, or product.

With the same understanding as in the Guidelines for Patent Examination, in this application, the expressions “greater than”, “less than”, “more than” and the like are understood as excluding this number; and the expressions “above”, “below”, “within” and the like are to be understood as including the present number. Furthermore, in the description of the embodiments of the present application, the meaning of “plurality” is two or more (including two), and similar expressions relating to “plurality” are also to be understood as such, e.g., “a plurality of groups”, “a plurality of times”, etc., unless explicitly and specifically limited otherwise.

In the description of the embodiments of the present application, spatially relative expressions are used, such as “center”, “longitudinal”, “transverse”, “length”, “width”, “thickness”, “upper”, “lower”, “front”, “rear”, “left”, “right”, “vertical”, “horizontal”, “perpendicular”, “top”, “bottom”, “inner”, “outer”, “clockwise”, “counterclockwise”, “axial”, “radial”, “circumferential”, etc. to indicate orientations or positional relationships based on the particular embodiments or the orientations or positional relationships shown in the drawings, merely for ease of description of the particular embodiments of the present application or for the reader's understanding. It is not intended or implied that a device or component referred to must have a particular position, a particular orientation, or be constructed or operated in a particular orientation, and thus should not be construed as limited to the embodiments set forth herein.

The use of the terms “mounted”, “connected”, “connecting”, “fixed”, “disposed”, and the like in the description of the embodiments of the present application is to be construed broadly unless explicitly stated or limited otherwise. For example, the “connection” may be a fixed connection, a detachable connection, or an integrated arrangement. It may be a mechanical connection, an electrical connection or a communication connection. It may be a direct connection or indirect connection by an intermediary. It may be in an interactive relationship between two elements, unless explicitly defined otherwise. For a person skilled in the art to which the present application belongs, the specific meaning of the above-mentioned wording in the embodiments of the present application can be understood according to specific situations.

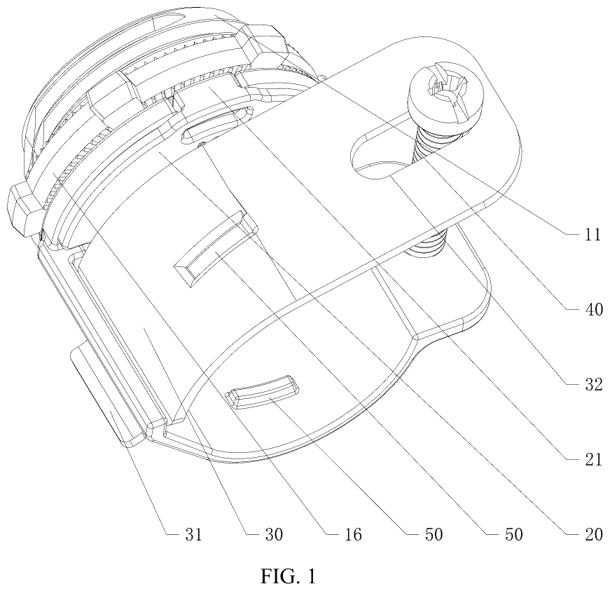

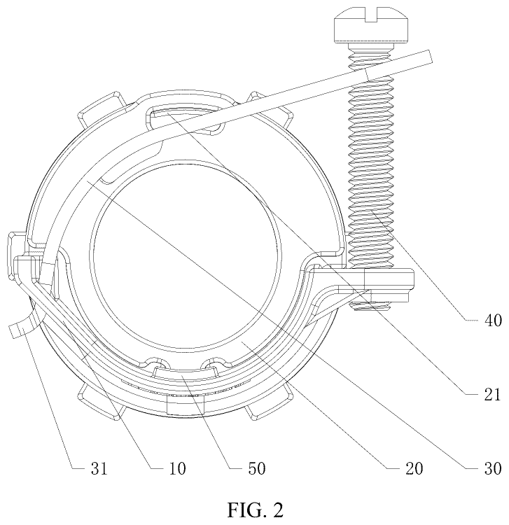

With reference to FIGS. 1 to 5 together, the present embodiment discloses an electrical connector for multiple cable sizes, including a body 10, a stop plate 20, a strap 30 and a fastener 40.

The body 10 includes a hollow cylindrical section 11 and a clamping section 12, wherein the clamping section 12 is connected to an end of the hollow cylindrical section 11. A slot 13 is provided at one side of the clamping section 12, and a first locking region 14 is provided at the other side of the clamping section 12.

The stop plate 20 is assembled at one end of the hollow cylindrical section 11 connected to the clamping section 12. The stop plate 20 is provided with an opening. The opening of the stop plate 20 is in communication with the inner side surface of the hollow cylindrical section 11. The opening size of the stop plate 20 is less than the inner diameter of the hollow cylindrical section 11.

A locking tab 31 is provided at one side of the strap 30, and a second locking region 32 is provided at the other side. The strap 30 is in contact with the slot 13 of the clamping section 12 via the locking tab 31, and a rotation point is formed in the contact region between the locking tab 31 and the slot 13 of the clamping section 12. A cable clamping region is formed in a region between the strap 30 and the clamping section 12.

The fastener 40 is connected to the first locking region 14 and the second locking region 32 for adjusting the size of the cable clamping region.

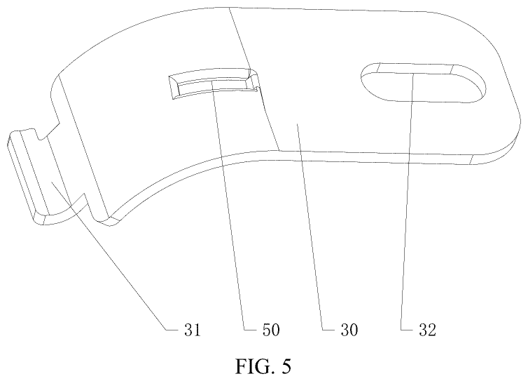

With reference to FIG. 5, as a preferred embodiment of the present application, a locking tab 31 is provided at one side of the strap 30. The locking tab 31 has an arc-shaped structure. The strap 30 contacts the slot 13 of the clamping section 12 via the locking tab 31 to form a rotation point in the contact region between the locking tab 31 and the slot 13 of the clamping section 12 and form a cable clamping region in the region between the strap 30 and the clamping section 12. During the assembly process, the arc-shaped locking tab 31 is inserted into the slot 13 of the clamping section 12 to detachably connect one side of the strap 30 with one side of the clamping section 12. By providing the locking tab 31 of the strap 30 with an arc-shaped structure, after the arc-shaped structure is loaded into the slot 13, the assembly region of the strap 30 is stabilized. The locking tab 31 can prevent the strap 30 from being separated from the slot 13 when the fastener 40 locks the first locking region 14 and the second locking region 32.

As a preferred embodiment of the present application, a locking tab 31 is provided at a side of the strap 30. The strap 30 is in contact with the slot 13 of the clamping section 12 via the locking tab 31. The locking tab 31 of the strap 30 is arranged at an included angle with the strap 30 to form a rotation point in the contact region between the locking tab 31 and the slot 13 of the clamping section 12 and form a cable clamping region in the region between the strap 30 and the clamping section 12. During the assembly process, the locking tab 31 arranged at an included angle with the strap 30 is inserted into the slot 13 of the clamping section 12 to detachably connect one side of the strap 30 with one side of the clamping section 12. By placing the locking tab 31 of the strap 30 at an included angle to the strap 30, the locking tab 31 can prevent the strap 30 from being separated from the slot when the fastener 40 locks the first locking region 14 and the second locking region 32.

As a preferred embodiment of the present application, the clamping section 12 of the body 10 has an arc-shaped structure. By making the clamping section 12 in an arc-shaped structure, the contact area with the cable is increased when the cable is fixed, improving the adaptability to cables of different sizes.

Referring to FIG. 5, as a preferred embodiment of the present application, the strap 30 has an arc-shaped structure. By making the strap 30 as an arc-shaped structure, the strap 30 as a clamping and fixing structure can increase the contact area with the cable and improve the stability of the cable clamping assembly.

According to the above structure, in the factory assembly process of the electrical connector for multiple cable sizes, the strap 30 is inserted into the slot 13 at one side of the clamping section 12 by the locking tab 31, so that the strap 30 may be rotated along the contact region of the slot 13 by the locking tab 31. A cable clamping region is formed between the strap 30 and the clamping section 12.

During the use of the electrical connector for multiple cable sizes, an operator selects a corresponding stop plate according to the actual flexible metal conduit or metal armoured cable or jacketed metal armoured cable. A stop plate 20 of a required size is loaded into one end of the hollow cylindrical section 11 of the body 10 connected to the clamping section 12, and then the cable required to be fixed is placed on the clamping section 12 firstly. The cable wire section enters the inside of the hollow cylindrical section 11 via the opening of the stop plate 20, and the outer protective structure of the cable is blocked by the stop plate 20. The operator then fixes and locks the strap 30 on the first locking region 14 and the second locking region 32 via the fastener 40. During the locking process, the cable can be clamped and fixed in the cable clamping region between the strap 30 and the clamping section 12 which adapts to the size of the cable, so as to complete the fixing of the cable. Latter, the fixing is performed by means of the region of the hollow cylindrical section 11 and the region to be butted on the equipment, so as to complete the assembly and butting process of the cable. The operator can install the clamping section 12 without disassembling the strap 30, saving time.

The hollow cylindrical section 11 of the body 10 is provided to facilitate the butting of cables. The clamping section 12 is provided at an end of the hollow cylindrical section 11. On one side, the locking tab 31 of the strap 30 is inserted into the body slot to facilitate the positioning and rotation. On the other side, the first locking region 14 and the second locking region 32 cooperate with the fastener 40 to clamp and fix the cables in the cable clamping region so as to facilitate the assembly and fixing for different cable sizes, and the opening size of the configured stop plate is less than the inner diameter of the hollow cylindrical section, which is possible to prevent the metal armor or flexible metal conduit of the cable from penetrating into the electrical equipment or electrical panel at the other end of the fitting opening of hollow cylindrical section from the body, thereby improving the assembly stability.

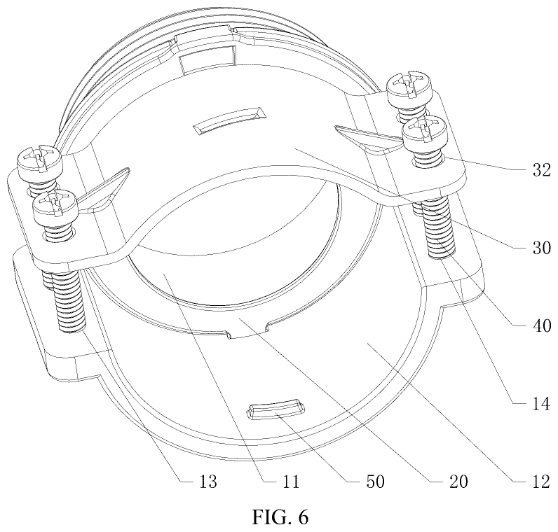

With reference to FIG. 6, in some preferred embodiments, a slot 13, which is a threaded hole structure, is provided at a side of the clamping section 12. The slot of the clamping section 12 is detachably connected to a pre-set opening on one side of the strap 30 via a bolt. When the strap 30 is formed with an opening, the size of the opening is greater than the size of the screw so as to adjust the angle of the strap 30. With the second locking region 32 provided on the other side of the strap 30, a cable clamping region is formed in the region between the strap 30 and the clamping section 12 by means of the fastener 40 with a bolt as well.

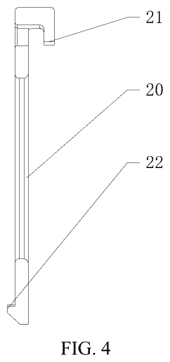

With reference to FIG. 4, as a preferred embodiment of the present application, the stop plate 20 is provided with a hook section 21 and a plug-in section 22. The hook section 21 is hooked on the hollow cylindrical section 11. In the present embodiment, a platform or a plate structure for facilitating the assembly of the stop plate 20 is preset on the hollow cylindrical section 11, so as to facilitate the assembly of the stop plate 20. A plug-in hole 15 is provided at one end of the clamping section 12 connected to the hollow cylindrical section 11. The plug-in section 22 is plugged into the plug-in hole 15. The hooking direction of the hook section 21 of the stop plate 20 and the plugging direction of the plug-in section 22 are arranged alternately. By providing the stop plate 20 with the hook section 21 and the plug-in section 22, it is possible to replace the stop plate 20 according to the specific sizes of the cable so as to adapt to the end abutting treatment of the cable protection structure.

In other embodiments, the stop plate 20 may abut in one surface against the hollow cylindrical section 11 directly, and the positioning process may be performed by the contact region between the hollow cylindrical section and the clamping section.

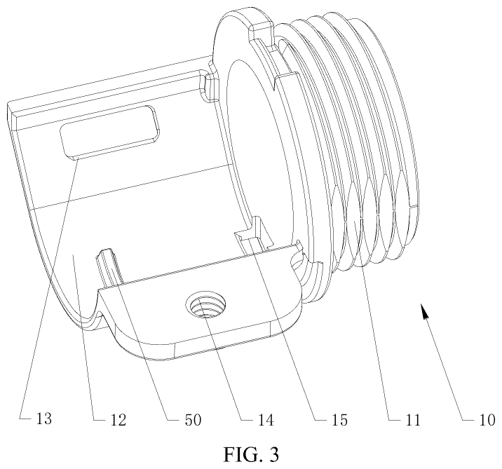

Referring to FIGS. 3 and 6, as a preferred embodiment of the present application, the outer surface of the hollow cylindrical section 11 is provided with an assembly thread that facilitate the cable butting and fixing process.

Referring to FIGS. 1, 3 and 6, as a preferred embodiment of the present application, a locknut 60 is also included, the locknut 60 being adapted to the assembly thread of the outer surface of the hollow cylindrical section 11. By providing the locknut 60, the fixing operation of the hollow cylindrical section 11 is facilitated.

Referring to FIGS. 1 and 6, in a preferred embodiment of the present application, the fastener 40 is a bolt, the first locking region 14 is a threaded hole, and the second locking region 32 is a threaded hole or through hole.

Referring to FIGS. 1 and 6, as a preferred embodiment of the present application, the strap 30 is provided with a fixed protrusion 50 on a side opposite to the clamping section 12. Further clamping and positioning of the outer surface of the cable, i.e., the flexible metal conduit or the metal armoured cable or the jacketed metal armoured cable, is facilitated by providing the fixed protrusion 50 on the side of the strap 30 opposite to the clamping section 12.

It should be noted that although the above-mentioned embodiments have been described herein, the scope of patent protection of the present invention is not limited thereby. Therefore, based on the innovative concept of the present invention, changes and modifications to the embodiments described herein, or transformation of equivalent structures or equivalent processes using the contents of the description and drawings of the present invention, it is intended to directly or indirectly apply the above technical solutions to other relevant technical fields, and all such changes and modifications are intended to be included in the scope of patent protection of the present invention.

What is claimed is:

1. An electrical connector for multiple cable sizes, including a body, a stop plate, a strap and a fastener;
the body includes an hollow cylindrical section and a clamping section, wherein the clamping section is connected to an end of the hollow cylindrical section; a slot is provided at one side of the clamping section, and a first locking region is provided at the other side of the clamping section;
the stop plate is assembled at one end of the hollow cylindrical section that connected to the clamping section; the stop plate is provided with an opening that communicate with the inner side surface of the hollow cylindrical section, and the size of the opening is less than the inner diameter of the hollow cylindrical section;
a locking tab is provided at one side of the strap, and a second locking region is provided at the other side; the strap contacts with the slot of the clamping section via the locking tab, and a rotation point is formed in the contact region between the locking tab and the slot of the clamping section; a cable clamping region is formed in a region between the strap and the clamping section; and the fastener is connected to the first locking region and the second locking region for adjusting the size of the space in the cable clamping region.

2. An electrical connector for multiple cable sizes according to claim 1, wherein the one side of the strap and the slot in one side of the clamping section can be connected or detached by a bolt that facilitate clamping and assembling operation.

3. An electrical connector for multiple cable sizes according to claim 1, wherein the strap has an arc-shaped structure that increases the contact area with the cable, improving the stability of the cable clamping and assembly.

4. An electrical connector for multiple cable sizes according to claim 1, wherein the locking tab is provided at one side of the strap; the locking tab has an arc-shaped structure; the strap is in contact with the slot of the clamping section via the locking tab, and a rotation point is formed in the contact region between the locking tab and the slot of the clamping section; a cable clamping region is formed in a region between the strap and the clamping section; by taking the locking tab of the strap as an arc-shaped structure, after the arc-shaped structure is inserted into the slot, the assembly region of the strap is stabilized; the locking tab can prevent the strap from being separated from the slot when the fastener locks the first locking region and the second locking region.

5. An electrical connector for multiple cable sizes according to claim 1, wherein the locking tab is provided at one side of the strap; the strap is in contact with the slot of the clamping section via the locking tab; the locking tab of the strap is arranged at an included angle with the strap, and a rotation point is formed in the contact region between the locking tab and the slot of the clamping section; a cable clamping region is formed in a region between the strap and the clamping section by arranging the locking tab of the strap at an included angle with the strap; when the strap adopts a flat plate structure, the locking tab can prevent the strap from being separated from the slot when the fastener locks the first locking region and the second locking region.

6. An electrical connector for multiple cable sizes according to claim 1, wherein the stop plate is provided with a hook section and a plug-in section; the hook section is hooked on the hollow cylindrical section; one end of the clamping section connected to the hollow cylindrical section is provided with a plug-in hole; the plug-in section is plugged in the plug-in hole; and the hooking direction of the hook section of the stop plate and the plugging direction of the plug-in section are arranged alternately; by providing the stop plate with a hook section and a plug-in section, it is possible to replace the stop plate according to the specific size of the cable so as to adapt to the end abutting treatment of the cable protection structure.

7. An electrical connector for multiple cable sizes according to claim 1, wherein the outer surface of the hollow cylindrical section is provided with an assembly thread that facilitate the cable butting and fixing process.

8. An electrical connector for multiple cable sizes according to claim 7, wherein the locknut being adapted to the assembly thread of the outer surface of the hollow cylindrical section; by providing a locknut, the fixing operation of the hollow cylindrical section is facilitated.

9. An electrical connector for multiple cable sizes according to claim 1, wherein the first locking region is a threaded hole, and the second locking region is a threaded hole or through hole.

10. An electrical connector for multiple cable sizes according to claim 1, wherein the strap is provided with a fixed protrusion on a side opposite to the clamping section; further clamping and positioning of the outer surface of the cable, i.e., the flexible metal conduit or the metal armoured cable or the jacketed metal armoured cable, is facilitated by providing the fixed protrusion on the side of the strap opposite to the clamping section.
